(19) United States
(12) Patent Application Publication
(10) Pub. No.: US 2006/0066540 A1
(43) Pub. Date: Mar. 30, 2006

(54) Spatial light modulation display system

(75) Inventors: Gregory J. Hewlett, Richardson, TX (US); Donald B. Doherty, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 10/951,995

(22) Filed: Sep. 27, 2004

(51) Int. Cl. G09G 3/34

(52) U.S. Cl. 345/84

(57) ABSTRACT

An improved display system includes LED light sources for providing red, green, and blue light. A controller for the display system includes a sequencer that controls the timing and sequence of image data to a spatial light modulator (e.g., a DMD) and activation of the light sources. The sequencer can control the timing and sequence of the light sources according to a display mode that can include such things as white point information, color-look information, timing of PWM sequences, and/or color cycle rate information. The display mode can be set during manufacturing or can be programmable. In some embodiments, the controller can include memory for storing multiple display modes and a user can select among the display modes to change the look of a displayed image. In some embodiments, a programming device can be provided allowing a user to customize the display modes.

### TECHNICAL FIELD

The present invention relates generally to display systems that use a spatial light modulation device.

### BACKGROUND

Spatial light modulation (SLM) display systems are display systems that use light reflected or transmitted by individual elements of a spatial light modulator to generate a display image. One type of spatial light modulator is a digital micromirror device (DMD). SLM display systems are known that incorporate a DMD, such as those commercially available from Texas Instruments, Inc. under the trademark DLP™ (Digital Light Processing).

FIG. 1 shows an example of an SLM projection display system 10. The system 10 includes an arc lamp 11 that emits white light. A first condenser lens 13 focuses the white light onto a color filter wheel 15. A second condenser lens 17 receives the filtered light and focuses it onto a DMD chip 19. The DMD chip 19 includes an array of tiny mirror elements, which together modulate the light and transmit the modulated light to projection lens 29, where it can be focused for display on the screen 31.

FIG. 2 shows a portion of a DMD array 19 having mirror elements 21 suspended over a substrate 23. Electrostatic attraction between the mirror 21 and an address electrode 25 causes the mirror 21 to twist or pivot, in either of two directions, about an axis formed by a pair of torsion beam hinges 27a and 27b. Typically, the mirror 21 rotates about these hinges until the rotation is mechanically stopped. The movable mirror 21 tilts into the on or off states by electrostatic forces depending on the data written to an associated memory cell (not shown). The tilt of the mirror 21 can be on the order of plus 10 degrees (on) or minus 10 degrees (off) to modulate the light that is incident on the mirrored surface. For additional details, see U.S. Pat. No. 5,061,049 entitled “Spatial Light Modulator” and U.S. Pat. No. 5,280,277 entitled “Field Updated Deformable Mirror Device,” both to Larry J. Hornbeck.

Referring again to FIG. 1, the color filter wheel 15 includes red (R), green (G), and blue (B) filter elements. The filter wheel 15 is driven by a motor 16 to rotate so that the different color filter elements sequentially filter the light passing through the filter wheel 15. Thus, as the filter wheel 15 rotates, the color of light emanating from the filter wheel 15 changes according to the wheel position. Typically the filter wheel 15 rotates at least once per frame for display of a multi-color image. The frequency of the rotation of the wheel 15 is controlled by a sequencer 33 based on the frame rate of image data received from an image source 35.

FIG. 3 shows an overview of the control of the display system 10. The sequencer 33 receives DMD control data that includes information regarding the frame rate of the image data. The sequencer 33 signals a wheel servo controller 38 to rotate the filter wheel 15 at a particular frequency according to the frame rate. As the filter wheel 15 rotates, the color of the light passing through the filter wheel 15 cycles through each of the filter colors. A sensor 37 detects the color of light coming from the filter wheel 15 and informs the sequencer 33 when the color changes. The sequencer 33 controls the DMD chip 19 in response to the color changes. For example, when the color of light coming from the filter wheel 15 turns red, the sequencer 33 controls the DMD chip 19 to modulate the light according to the red portions of the image data. A more detailed description of this type of control system is described in U.S. Patent Application Publication No. 2003/0227677 to Doherty et al. entitled “Display System with Clock-Dropping to Compensate for Lamp Variations and for Phase Locking of Free-Running Sequencer” and in U.S. Patent Application Publication No. 2003/0227465 to Morgan et al. entitled “Constant-Weight Bit-Slice PWM Method and System for Scrolling Color Display Systems.”

### SUMMARY

Display systems such as the one discussed above offer only limited versatility as to color ordering and timing since color-switching must be synchronized with the rotation of the color wheel. In addition, the color wheel and motor assembly introduces uncertainties into the system, for example due to motor jitter, which must be accounted for by complex processing techniques and/or introduction of idle times in the imaging sequence.

The improved display system disclosed herein includes light sources for providing red, green, and blue light. In a preferred embodiment, the light sources are LEDs. By using colored light sources, the improved display system eliminates the color wheel and motor assembly and the uncertainties associated with them. In addition, the color-switching sequences in the display system can now be fully controlled, even firmware- or software-driven, allowing complete versatility as to color ordering and timing.

A controller for the display system includes a sequencer that controls the timing and sequence of image data to a spatial light modulator (e.g., a DMD) and activation of the light sources. The sequencer can control the timing and sequence of the light sources according to a display mode that can include such things as white point information, color-look information, timing of PWM sequences, and/or color cycle rate information. The display mode can be set during manufacturing or can be programmable. In some embodiments, the controller can include memory for storing multiple display modes and a user can select among the display modes to change the look of a displayed image. In some embodiments, a programming device can be provided allowing a user to customize the display modes.

### BRIEF DESCRIPTION OF THE DRAWINGS

Embodiments are illustrated by way of example in the accompanying figures, in which like reference numbers indicate similar parts, and in which:

FIG. 1 shows a block diagram of a conventional DMD-based display system;

FIG. 2 shows a perspective view of an array of DMD mirrors;

FIG. 3 shows a block diagram providing a more detailed view of the control of the display system shown in FIG. 1;

FIG. 4 shows an embodiment of a spatial light modulation (SLM) display system;

FIG. 5 shows a block diagram of an embodiment of a system controller for the display system shown in FIG. 4;

FIG. 6 shows a flowchart of a process for deleting, modifying, and creating display modes; and

FIG. 7 shows an alternate embodiment of an SLM display system.

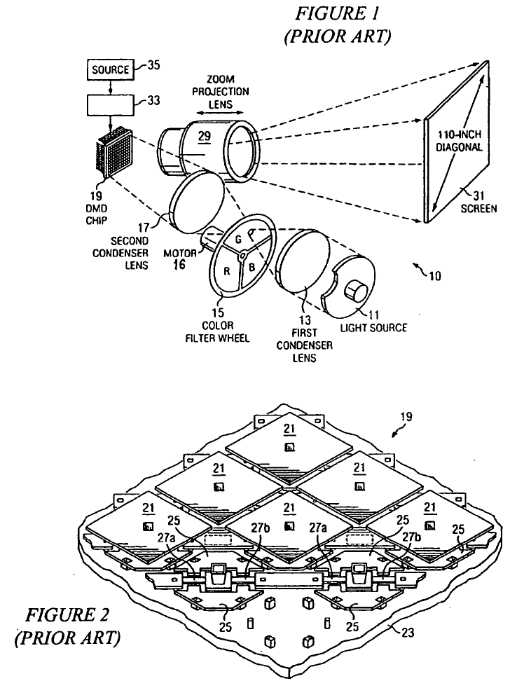

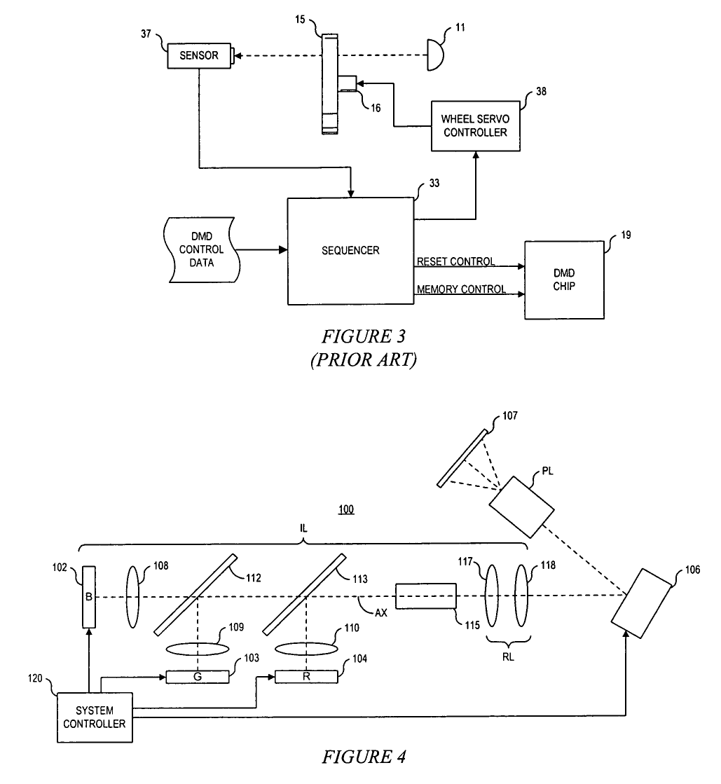

### DETAILED DESCRIPTION

FIG. 4 shows an optical construction for a spatial light modulation (SLM) display system 100. The display system 100 includes a first light source 102, a second light source 103, and a third light source 104. The display system 100 also includes, along an optical axis AX, an illumination optical system IL, a DMD 106, and a projection optical system PL for projecting an image onto a projection surface 107. The light sources 102-104 and the DMD 106 operate according to instructions received from a system controller 120, discussed in greater detail below.

The light sources 102-104 each include a light emitting diode (LED), or an array of LEDs, for emitting a respective one of three primary colors. In the present embodiment, the first light source 102 includes an LED array for emitting blue light, the second light source 103 includes an LED array for emitting green light, and the third light source 104 includes an LED array for emitting red light. However, other colors and arrangements of colors can be used.

The light radiated from the light sources 102-104 is directed through the illumination optical system IL to the DMD 106. The illumination optical system IL comprises a plurality of optical elements for directing and smoothing the light from the light sources 102-104.

The illumination optical system IL includes collimating lenses 108-110 for collimating light from the light sources 102-104. Specifically, the blue light from the first light source 102 is collimated by a collimating lens 108, the green light from the second light source 103 is collimated by a collimating lens 109, and the red light from the third light source 104 is collimated by a collimating lens 110.

The illumination optical system IL also includes a pair of filter elements 112 and 113. The first filter element 112 passes the blue light and reflects the green light. The second filter element 113 passes the blue and green light and reflects the red light. In some embodiments, the filter elements 112 and 113 can be optical elements having a dichroic surface for filtering. Here, in order to improve a use efficiency of the light from the light sources 102-104, polarization converting means for aligning polarizing directions of the light from the light sources 102-104 can be provided, for example between the light sources 102-104 and the filter elements 112, 113.

As mentioned above, the illumination optical system IL performs a function of smoothing the light from the light sources 102-104. Smoothing the light makes it possible to minimize the difference in brightness between axial and off-axial rays on the display surface of the DMD 106, thereby improving the brightness distribution uniformity. This smoothing of illumination light is achieved by an integrator rod 115.

The illumination optical system IL further includes a relay lens unit RL for relaying light from the integrator rod 115 to the DMD 106. In the present embodiment, the relay lens unit RL includes a first relay lens 117 and a second relay lens 118. However, those skilled in the art will appreciated that other configurations and combinations of optical elements can be used as needed for the relay lens unit RL.

The DMD 106 includes an array of tiny mirror elements, which together modulate the light received from the illumination optical system IL and transmit the modulated light to the projection optical system PL, where it can be focused for display on the projection surface 107, such as a screen. The projection optical system PL can include any number of optical elements for projecting the image light modulated by the DMD 106 onto the projection surface 107 located at a predetermined distance or within a predetermined range of distances. The DMD 106 is so constructed that each of its mirror elements is in one of two differently inclined states, namely either in an ON state or in an OFF state. The DMD 106 is configured such that only mirror elements in their ON state reflect the illumination light towards the projection optical system PL. Thus, the portion of the illumination light reflected by the mirror elements in their ON state passes through the projection optical system PL and eventually forms a display image on the projection surface 107.

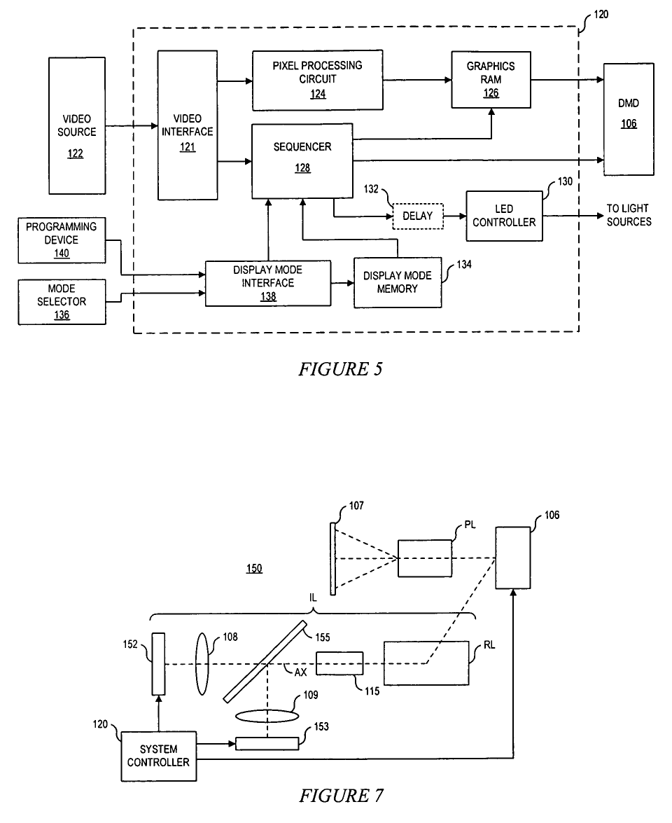

FIG. 5 shows a block diagram of the system controller 120. The system controller 120 includes a video interface 121 for receiving video signals from a video source 122. The video signal can be in any of a number of different types of signals in any format, including digital RGB video or graphics data. The video source 122 can include any of a number of devices, including a computer, a set-top box for cable or satellite television, a television antenna or many other sources.

The video interface 121 can be constructed to receive one or more different types of video signals. The video interface 121 separates the input video signal into its components and converts the signals to digital signals. Alternatively, the video interface 121 can be constructed to receive video signals in digital form. The video interface 121 can be constructed, for example, in accordance with the teachings of U.S. Pat. No. 5,526,051, entitled “Digital Television System”, assigned to Texas Instruments Incorporated, which is hereby incorporated by reference. The video interface 121 produces a digitized version of the input signal in the form of input pixel data.

A pixel processing circuit 124 receives the input pixel data from the video interface 121. The pixel processing circuit 124 can include circuitry capable of performing various processing tasks on the video pixel data produced by the video interface 121. Such circuitry can include digamma circuitry, color hue correction circuitry, blue noise spatial temporal multiplexing (STM) circuitry, and noise-free boundary dispersion circuitry. After the pixel processing circuit 124 has processed the input video pixel data, it feeds frames of output video pixel data into a graphics RAM 126, which serves as a frame buffer.

The graphics RAM 126 comprises a memory capable of storing one or more complete video frames. The video frames may be stored, for example, in the graphics RAM 126 as a set of bit-planes. For example, where the pixel data has an 8-bit per color format, the data can be stored as 24 bit-planes. Each bit plane corresponds to one bit of an eight bit value representing the intensity of one of the three primary colors of light. Because there are three eight-bit values, 24 bit planes are stored. Alternative forms of storage are readily contemplated and the pixel data can alternately be stored as groups of bits, rather than as individual bit planes. The graphics RAM 126 can be a dynamic random access memory array, for example a double data rate synchronous random access memory.

At the appropriate time, the output video pixel data stored in the graphics RAM 126 is transferred to the DMD 106 for display. As explained below, the light sources 102-104 are controlled to provide the blue, green, and red light, respectively, to the DMD 106, allowing the DMD 106 to produce a color video image composed of a plurality of colors created by combining the primary colors of light supplied by the light sources 102-104.

A sequencer 128 also receives the input pixel data from the video interface 121. In response to this signal, the sequencer 128 controls the timing of transfers of output video pixel data from the graphics RAM 126 to the DMD 106, the location in the graphics RAM 126 where the data is transferred from, the position on the DMD 106 where the output pixel data is displayed, and the timing necessary to display the data. The sequencer 128 also provides instructional color data to an LED controller 130 for controlling activation of the light sources 102-104 according to colors associated with the output video pixel data. The sequencer 128 receives a timing signal from the video interface 121 with a frequency equivalent to the frequency that video frame lines are displayed on the DMD 106. The sequencer 128 receives a synchronization signal from the graphics RAM 126 indicating that a complete video frame has been transferred to the graphics RAM 126. The sequence of timing instructions needed to generate the addresses and timing signals necessary to display an entire frame of video data can be stored in a timing memory (not shown) internal to the sequencer 128, or alternately in a separate memory.

The LED controller 130 includes logic for decoding the instructional color data received from the sequencer 128. The LED controller 130 provides control signals for activating the light sources 102-104 according to the instructional color data. In some embodiments, an optional fixed or pre-programmed delay 132 can be included as needed to allow for synchronous operation of the DMD 106 and the light sources 102-104.

The system controller 120 allows for the sequencer 128 to have full control of the illumination. In prior systems, the sequence of displayed images was limited because it had to be controlled according to a fixed sequence and timing of colors emanating from a rotating color wheel. The system controller 120 is not subject to such restrictions since it has full control of the color output sequence as needed for a desired image sequence. For example, the sequencer 128 can include software or firmware control for finer levels of colors and for motion artifact reduction.

The sequencer 128 can control the color output and sequence according to a selectable display mode. Instructions for the display mode or modes can be stored in a display mode memory 134, or alternately within the sequencer 128 itself. Each mode can include unique instructions that change the color look/PWM timing for a displayed image. For example, different modes can have different white points or color cycle rates (e.g., 20×, 8×, 6×, 4×, etc.), where a color cycle rate defines the number of times each color occurs per frame. Modes can be designated for simulating a certain “look” for a displayed image (e.g., video look, film look, etc.). The modes can also include independent cycle rates for each color (e.g., Green 8×, Red 4×, Blue 6×).

A user can select from among the modes stored in the display mode memory 134 using a mode selector 136. The mode selector 136 can be any type of user-controllable device, for example comprising a control panel, a remote-control device, or a graphical user interface. The mode selector 136 communicates a mode-select signal to a display mode interface 138.

The display mode interface 138 can be constructed to receive one or more different types of signals. The display mode interface 138 converts the mode-select signals to digital signals. Alternatively, display mode interface 138 can be constructed to receive mode-select signals in digital form. The display mode interface 138 interprets the mode-select signal and provides instructions to the sequencer 128. The sequencer 128 can then retrieve data for the selected mode from the display mode memory 134.

The display mode interface 138 can also receive instructions for creation or modification of display modes from a programming device 140. In some embodiments, the programming device 140 can be computer or other type of processing device coupled to the display system 100, wired or wirelessly, where the computer is controlled by software that allows a user to delete, create, and/or modify display modes. Alternately, the programming device 140 can be a processor included in the display system 100, for example including a control panel (not shown) having a user interface.

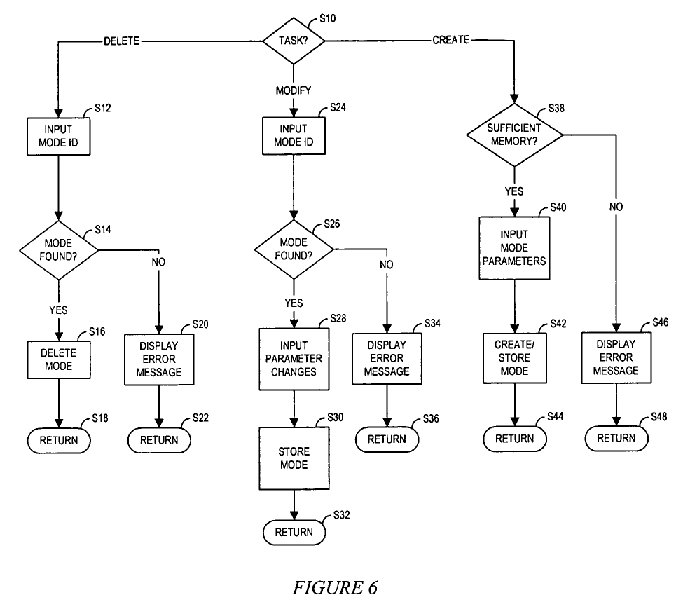

The programming device 140 can function according to a process that is illustrated in the flowchart shown in FIG. 6. The process shown in FIG. 6 is but one of several possible embodiments and can obviously be modified in many ways without departing from the concepts being conveyed. The process includes step S10, where a user can select among a variety of tasks, for example from a menu displayed on a user interface, in this case the selectable tasks being “DELETE”, “MODIFY”, and “CREATE”.

If the user selects “DELETE” at step S10, the process continues to step S12, where the user identifies the mode to be deleted, for example by providing a mode name, id number, or memory location. Alternately, a list of available modes can be displayed, and the user can select a mode to be deleted. At step S14, the programming device queries the display mode memory 134 to locate the mode identified in step S14. If the mode is located (“YES” at step S14), the programming device 140 issues instructions to delete the mode at step S16, then at step S18 returns to the task select step S10. Otherwise, if the mode is not located (“NO” at step S14), an error message is displayed at step S20, and then at step S22 the process returns to task select step S10.

If the user selects “MODIFY” at step S10, the process continues to step S24, where the user identifies the mode to be modified, for example by providing a mode name, id number, or memory location. Alternately, a list of available modes can be displayed, and the user can select a mode to be modified. At step S26, the programming device queries the display mode memory 134 to locate and retrieve the mode identified in step S14. If the mode is located and retrieved (“YES” at step S26), the programming device 140 inputs changes from the user to the mode parameters at step S28. The mode parameters can include a mode identifier, high-level display settings, for example allowing a user to specify a certain “look” (e.g., film look, video look, mono or duotone look, etc.) and/or low-level display settings, for example specifying desired timing or PWM settings, color settings (e.g., white point, color tint, etc.), or color cycle rates, which can be global color cycle rates that apply to all colors or independent color cycle rates for each color. The modified mode data is then sent to be stored in the display mode memory 134 at step S30, and then at step S32 returns to the task select step S10. Otherwise, if the mode cannot be located or retrieved (“NO” at step S26), an error message is displayed at step S34, and then at step S36 the process returns to task select step S10.

If the user selects “CREATE” at step S10, the process continues to step S38, where the programming device queries the display mode memory 134 to determine whether sufficient memory space exists for storing display mode data for a new mode. If sufficient memory space exists (“YES” at step S38), the programming device 140 inputs mode parameters from the user at step S40. The mode parameters can include a mode identifier, high-level display settings, for example allowing a user to specify a certain “look” (e.g., film look, video look, mono or duotone look, etc.) and/or low-level display settings, for example specifying desired timing or PWM settings, color settings (e.g., white point, color tint, etc.), or color cycle rates, which can be global color cycle rates that apply to all colors or independent color cycle rates for each color. The new mode is then created and sent to be stored in the display mode memory 134 at step S42, and then at step S44 returns to the task select step S10. Otherwise, if sufficient memory space does not exist (“NO” at step S38), an error message is displayed at step S46, and then at step S48 the process returns to task select step S110.

Allowing the sequencer 128 to control color output as is done in the controller 120 allows for several advantages. For one, it allows for greater versatility as to color ordering and timing (e.g., color ordering is not limited to the color pattern of a filter wheel, timing is not limited by wheel speed, etc.). It also allows for rapid switching of colors in an environment where synchronization of sequence to color illumination can be ensured. It removes timing uncertainties, such as those commonly associated with color-wheel technology, so that illumination can be guaranteed, for example for a period within a microsecond. It can also allow for a production process time-to-market decrease because color ordering can be implemented in software form.

The control system 120 has been illustrated to include eight functional blocks (including optional delay 132). It is understood, however, that the delineation of particular functions is somewhat arbitrary and that each of these functions could be performed in one or more different integrated circuits that operate according to circuit design and/or software control. The functional blocks are labeled here for purposes of illustration and several of the functions can be combined of separated in various circuits or other functional units. The control system 120 is not limited to use with the display system 100; rather it can be used with a variety of illumination systems, particularly those including or using plural light sources and a spatial modulation device.

FIG. 7 shows an optical construction for an alternate spatial light modulation (SLM) display system 150. The display system 150 includes a first light source 152 and a second light source 153. The display system 150 also includes, along an optical axis AX, an illumination optical system IL, a DMD 106, and a projection optical system PL for projecting an image onto a projection surface 107. The light sources 152, 153 and the DMD 106 operate according to instructions received from the system controller 120, as discussed above.

Differences between the alternate display device 150 and the display device 100 include a difference in the number of light sources and a variation in the optics used for the relay lens unit RL. Specifically, the alternate display device 150 includes a first light source 152 for emitting red or blue light (e.g., an array of light elements including red and blue light-emitting elements such as an R/B LED package) and a second light source 153 that can be controlled to emit green light. As a result, the filtering characteristics of the filter element 155 allows for passing light in the red and blue color ranges, and reflecting light in the green color range. Also, in the alternate display device 150 the relay lens unit RL includes optical elements for changing a direction of the optical axis AX, for example through the use of prism and/or mirror elements according to known techniques.

Thus, it will be appreciated that the system controller 120 used in conjunction with the alternate display device 150 is adapted to send control signals to two light sources rather than three. For example, the LED controller 130 can control the first light source 152 to emit light that is red or blue of varying intensities, for example by controlling the voltage level of a signal or set of signals provided to the first light source 152.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A display system comprising:
a plurality of light sources;
a spatial light modulator located to receive light from the light sources, the spatial light modulator including a plurality of independently controllable elements that can be activated for a period of time for directing light from the light sources for display; and
a sequencer for receiving image data and issuing control signals for modulation of selected light sources.

2. A system according to claim 1, wherein the plurality of light sources comprises at least one light emitting diode.

3. A system according to claim 1, wherein the plurality of independently controllable elements comprises a digital micromirror device mirror.

4. A system according to claim 1, wherein the image data is organized in a series of frames and the sequencer issues control signals for activating each of the light sources a specified number of times per frame.

5. A system according to claim 4, wherein the specified number of times per frame is based on display mode data.

6. A system according to claim 5, further comprising a display mode interface for receiving display mode data.

7. A system according to claim 5, further comprising a display mode memory for storing display mode data for one or more display modes.

8. A system according to claim 7, further comprising a display mode interface for receiving a mode-select signal and instructing the sequencer to set a display mode based on the received mode-select signal.

9. A system according to claim 8, further comprising a programming device for allowing a user to set the specified number of times per frame for each light source.

10. A system according to claim 4, wherein the plurality of light sources comprises light sources for emitting respective colors of light, and wherein the specified number of times per frame is unique for each color.

11. A system according to claim 1, wherein the plurality of light sources comprises light sources for emitting respective colors of light, and wherein the sequencer controls issues control signals for providing a unique intensity for each color.

12. A system controller for a display system having a spatial light modulator and a plurality of light sources, the controller comprising:
an interface for receiving video signals and issuing image data based on the video signals; and
a sequencer for controlling a transfer of said image data to the spatial light modulator and for issuing instructional color data for controlling activation of the light sources.

13. A system controller according to claim 12, further comprising a light controller for decoding instructional color data received from the sequencer and issuing control signals according to the instructional color data.

14. A system controller according to claim 13, further comprising a display mode memory for storing display mode data, wherein the sequencer controls activation of the light sources according to display mode data received from the display mode memory.

15. A system controller according to claim 14, further comprising a display mode interface for receiving display mode data from a programming device and storing the display mode data in the display mode memory.

16. A system controller according to claim 14, further comprising a display mode interface for receiving a mode-select signal from a mode selector and instructing the sequencer to operate according to a selected display mode according to the mode-select data.

17. A method of displaying pixel data, the method comprising:
receiving image data;
determining an activation duration of a spatial light modulator element based on the received image data;
determining a color of light used to display the pixel data;
controlling a plurality of light sources to selectively emit light.

18. A method according to claim 17, wherein the plurality of light sources comprises at least one light emitting diode.

19. A method according to claim 17, wherein the plurality of independently controllable elements comprises a digital micromirror device mirror.

20. A method according to claim 17, wherein the image data is organized in a series of frames and the controlling of the plurality of light sources includes issuing control signals for activating each of the light sources a specified number of times per frame.

21. A method according to claim 20, wherein the specified number of times per frame is based on display mode data.

22. A method according to claim 21, further comprising receiving display mode data from a display mode interface.

23. A method according to claim 21, further comprising storing display mode data for one or more display modes in a display mode memory.

24. A method according to claim 23, further comprising a step of receiving a mode-select signal and instructing the sequencer to set a display mode based on the received mode-select signal.

25. A method according to claim 24, further comprising a step of receiving instructions from a user to set the specified number of times per frame for each light source.

26. A method according to claim 20, wherein the plurality of light sources comprises light sources for emitting respective colors of light, and wherein the specified number of times per frame is unique for each color.

27. A method according to claim 17, wherein the plurality of light sources comprises light sources for emitting respective colors of light, and wherein the controlling of the plurality of light sources includes providing a unique intensity for each color.
